(19) United States
(12) Patent Application Publication
(10) Pub. No.: US 2013/0265349 A1
(43) Pub. Date: Oct. 10, 2013

(54) CONTENT-PRESERVING SCREEN SAVER

(71) Applicant: Leslie Chiming Chan, San Diego, CA (US)

(72) Inventor: Leslie Chiming Chan, San Diego, CA (US)

(73) Assignee: QUALCOMM MEMS TECHNOLOGIES, INC., San Diego, CA (US)

(21) Appl. No.: 13/442,647

(22) Filed: Apr. 9, 2012

(51) Int. Cl. G09G 5/00

(52) U.S. Cl. 345/698

(57) ABSTRACT

A content-preserving screen saver (CPSS) method for controlling a display apparatus is disclosed. When a CPSS method is implemented, the screen content may be displayed at a relatively lower resolution, such as half resolution or some other fraction of full resolution, by deactivating some of the display pixels or subpixels. The CPSS may be activated, for example, if no user input is received (and/or if another event does not occur) for a predetermined period of time. In one half-resolution example, every other pixel of the display is turned off when the CPSS is activated. After another predetermined period of time, all pixels are “flipped”: pixels that were on are turned off, and pixels that were off are turned on. In alternative implementations, more or fewer than half of the pixels may be switched off to achieve other partial resolution states, such as 75% resolution, ⅔ resolution, ⅓ resolution, etc.

### TECHNICAL FIELD

This disclosure relates to display devices, including but not limited to display devices that incorporate electromechanical systems.

### DESCRIPTION OF THE RELATED TECHNOLOGY

Electromechanical systems (EMS) include devices having electrical and mechanical elements, actuators, transducers, sensors, optical components (including mirrors) and electronics. EMS can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). As used herein, the term IMOD or interferometric light modulator refers to a device that selectively absorbs and/or reflects light using the principles of optical interference. In some implementations, an IMOD may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the IMOD. IMOD devices have a wide range of applications, and are anticipated to be used in improving existing products and creating new products, especially those with display capabilities.

When a display element (a pixel or subpixel) is activated continuously for a long period of time, a “burn-in” effect may occur such that the display element may stay in the activated state even when not activated by the display control system. Burn-in is a well-known phenomenon for cathode ray tube and plasma displays, but burn-in is also a problem for other types of displays, including IMOD displays and liquid crystal displays (LCDs).

The traditional method for preventing burn-in is to execute screen saver software to display changing and/or moving images on the display. Although screen saver programs are generally acceptable, it would be desirable to have improved methods and devices for preventing burn-in.

### SUMMARY

The systems, methods and devices of the disclosure each have several innovative aspects, no single one of which is solely responsible for the desirable attributes disclosed herein.

One innovative aspect of the subject matter described in this disclosure can be implemented as a content-preserving screen saver (CPSS) method for controlling a display apparatus. When a CPSS method is implemented, the screen content may be displayed at a relatively lower resolution, such as half resolution or some other fraction of full resolution, by deactivating some of the display pixels or subpixels. The CPSS may be activated, for example, if no response (such as user input) is received for a predetermined period of time. In one half-resolution example, every other pixel of the display is turned off when the CPSS is activated. After another predetermined period of time, all pixels may be “flipped”: pixels that were on may be turned off, and pixels that were off may be turned on. In alternative implementations, more or fewer than half of the pixels may be initially (or subsequently) switched off to achieve other partial resolution states, such as 75% resolution, ⅔ resolution, ⅓ resolution, etc.

Another innovative aspect of the subject matter described in this disclosure can be implemented as a method that involves operating a display at a full resolution, determining that no user input has been received for a first time period and operating the display at a first partial resolution. Operating the display at the first partial resolution may involve operating substantially the entire the display at the first partial resolution. Operating the display at the first partial resolution may occur because of the determination that no user input has been received for the first time period. The method also may involve determining that no user input has been received for a second time period and operating the display at a second partial resolution that is a lower resolution than the first partial resolution.

Operating the display at the first partial resolution may involve switching off a first plurality of display elements. The display elements may include pixels or subpixels. Operating the display at the first partial resolution may involve switching off a first plurality of pixels.

The method also may involve determining that no user input has been received for a second time period, switching on at least some of the first plurality of pixels and switching off a second plurality of pixels. The first plurality of pixels may be substantially half of a total number of display pixels. Switching off the first plurality of pixels may involve switching off every other pixel.

The method also may involve determining that no user input has been received for a second time period, switching on the first plurality of pixels and switching off a second plurality of pixels. The second plurality of pixels may include substantially all of the pixels of the display other than the first plurality of pixels.

In some implementations, the first plurality of pixels may include approximately ⅔ of the pixels of the display. Switching off the first plurality of pixels may involve switching off every second and third pixel.

In alternative implementations, the first plurality of pixels may include approximately ¾ of the pixels of the display. Switching off the first plurality of pixels may involve switching off every second, third and fourth pixel.

Another innovative aspect of the subject matter described in this disclosure can be implemented as an apparatus that includes a display, at least one user input device and a control system configured for communication with the display and the user input device. The user input device(s) may include at least one of a touch screen, a keyboard, a mouse, a key pad, a microphone, a camera or a gesture-sensing apparatus. The control system may be configured for operating the display at a full resolution, determining that no user input has been received from the user input device for a first time period and operating substantially the entire display at a first partial resolution. Operating the display at the first partial resolution may involve switching off a first plurality of pixels. The control system may be further configured for determining that no user input has been received for a second time period and operating the display at a second partial resolution that is a lower resolution than the first partial resolution.

The control system may be further configured for determining that no user input has been received for a second time period, switching on at least some of the first plurality of pixels and switching off a second plurality of pixels. The first plurality of pixels may be substantially half of a total number of display pixels. Switching off the first plurality of pixels may involve switching off every other pixel.

The control system may be further configured for determining that no user input has been received for a second time period, switching on the first plurality of pixels and switching off a second plurality of pixels. The second plurality of pixels may include substantially all of the pixels of the display other than the first plurality of pixels.

In some implementations, the first plurality of pixels may include approximately ⅔ of the pixels of the display. Switching off the first plurality of pixels may involve switching off every second and third pixel.

In alternative implementations, the first plurality of pixels may include approximately ¾ of the pixels of the display. Switching off the first plurality of pixels may involve switching off every second, third and fourth pixel.

Another innovative aspect of the subject matter described in this disclosure can be implemented as a non-transitory medium having software stored thereon. The software may include instructions for operating a display at a full resolution, determining that no user input has been received for a first time period and operating substantially the entire display at a first partial resolution. Operating the display at the first partial resolution may involve switching off a first plurality of pixels.

The software may include instructions for determining that no user input has been received for a second time period, switching on at least some of the first plurality of pixels and switching off a second plurality of pixels. The second plurality of pixels may include substantially all of the pixels of the display other than the first plurality of pixels. In some implementations, the first plurality of pixels may be substantially half of the total number of display pixels. Switching off the first plurality of pixels may involve switching off every other pixel.

Details of one or more implementations of the subject matter described in this specification are set forth in the accompanying drawings and the description below. Although the examples provided in this summary are primarily described in terms of MEMS-based displays, the concepts provided herein apply to other types of displays, such as liquid crystal displays (LCDs), plasma displays, organic light-emitting diode (“OLED”) displays, field emission displays, etc. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 IMOD display.

FIG. 3 shows an example of a diagram illustrating movable reflective layer position versus applied voltage for the IMOD of FIG. 1.

FIG. 4 shows an example of a table illustrating various states of an IMOD when various common and segment voltages are applied.

FIG. 5A shows an example of a diagram illustrating a frame of display data in the 3×3 IMOD display of FIG. 2.

FIG. 5B shows an example of a timing diagram for common and segment signals that may be used to write the frame of display data illustrated in FIG. 5A.

FIG. 6A shows an example of a partial cross-section of the IMOD display of FIG. 1.

FIGS. 6B-6E show examples of cross-sections of varying implementations of IMODs.

FIG. 7 shows an example of a flow diagram illustrating a manufacturing process for an IMOD.

FIGS. 8A-8E show examples of cross-sectional schematic illustrations of various stages in a method of making an IMOD.

FIG. 9 shows an example of a flow diagram illustrating a process of controlling a display according to some implementations provided herein.

FIGS. 10A-10F show examples of displays being controlled according to a process outlined in FIG. 9.

FIG. 11 shows an example of a flow diagram illustrating a process of controlling a display according to some alternative implementations provided herein.

FIGS. 12A-12D show examples of displays being controlled according to an alternative process outlined in FIG. 11.

FIGS. 13A and 13B show examples of system block diagrams illustrating a display device.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device or system that can be configured to display an image, whether in motion (e.g., video) or stationary (e.g., still image), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (i.e., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS), microelectromechanical systems (MEMS) and non-MEMS applications), aesthetic structures (e.g., display of images on a piece of jewelry) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

When a display element such as a pixel or subpixel is activated continuously for a long period of time, the display element may stay in the activated state even when not activated by the display control system. This effect is often referred to as “burn-in.” Burn-in can adversely affect many types of displays, including but not limited to plasma displays, IMOD displays and LCDs. Conventional methods for preventing burn-in include changing and/or moving images on the display. According to these methods, the original content is not shown on the display when the screen saver is active.

When a CPSS method is implemented for controlling a display apparatus, the screen content may be displayed at a relatively lower resolution by deactivating some of the display elements (pixels or subpixels). (As used herein, “resolution” is synonymous with “pixel density.”) The CPSS may be activated, for example, if no response (e.g., no user input) is received for a first predetermined period of time. For example, every other pixel of the display may be turned off after a first predetermined period of time elapses with no user input. After another predetermined period of time, at least some of the pixels that were left on may be switched off, and at least some pixels that were initially switched off may be turned on.

Particular implementations of the subject matter described in this disclosure can be implemented to realize one or more of the following potential advantages. When a CPSS method is implemented for controlling a display apparatus, the resulting image may appear hazy but will still preserve the images, text and other content that was being displayed. Operating a display device according to a CPSS method may reduce power consumption, primarily because some portion of the display pixels are sometimes switched off even while content is still being displayed.

An example of a suitable EMS or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the IMOD. The reflectance spectrums of IMODs can create fairly broad spectral bands which can be shifted across the visible wavelengths to generate different colors. The position of the spectral band can be adjusted by changing the thickness of the optical resonant cavity. One way of changing the optical resonant cavity is by changing the position of the reflector.

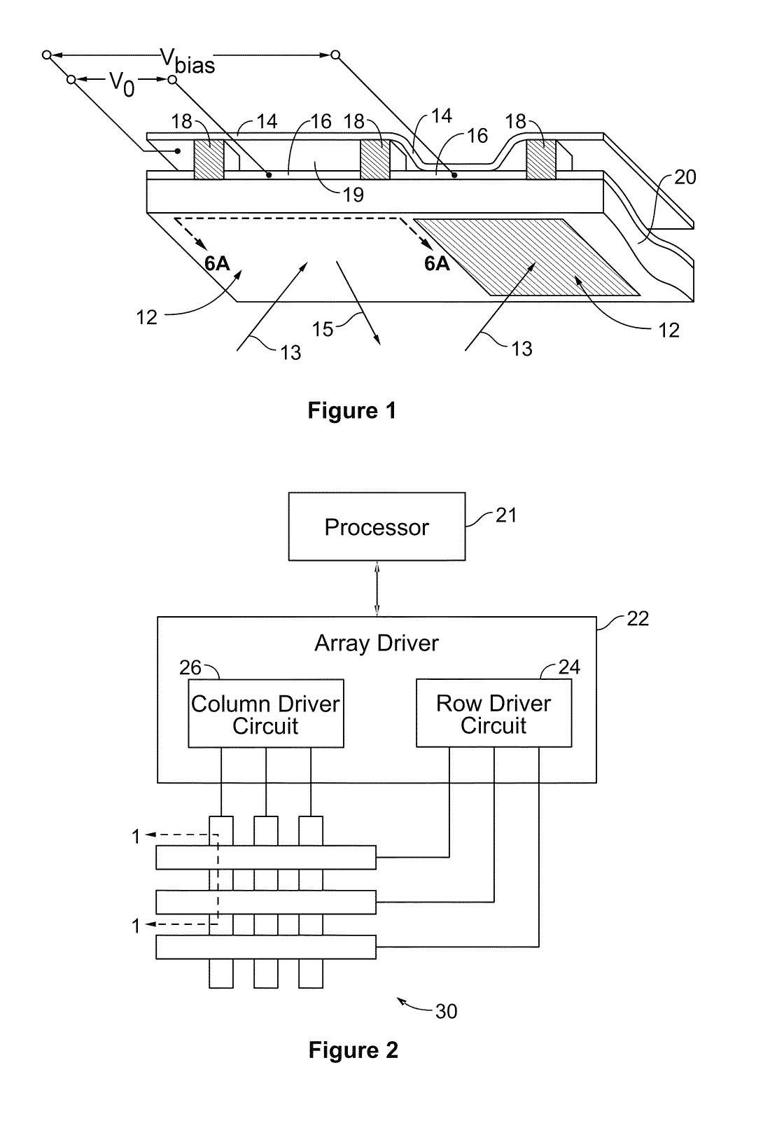

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, absorbing and/or destructively interfering light within the visible range. In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent IMODs 12 (i.e., IMOD pixels). In the IMOD 12 on the left (as illustrated), a movable reflective layer 14 is illustrated in a relaxed position at a distance (which may be predetermined based on design parameters) from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near, adjacent or touching the optical stack 16. The voltage V_{bias} applied across the IMOD 12 on the right is sufficient to move and can maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. A person having ordinary skill in the art will readily recognize that most of the light 13 incident upon the pixels 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, such as chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and electrical conductor, while different, more electrically conductive layers or portions (e.g., of the optical stack 16 or of other structures of the IMOD) can serve to bus signals between IMOD pixels. The optical stack 16 also can include one or more insulating or dielectric layers covering one or more conductive layers or an electrically conductive/optically absorptive layer.

In some implementations, the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be approximately less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 IMOD display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

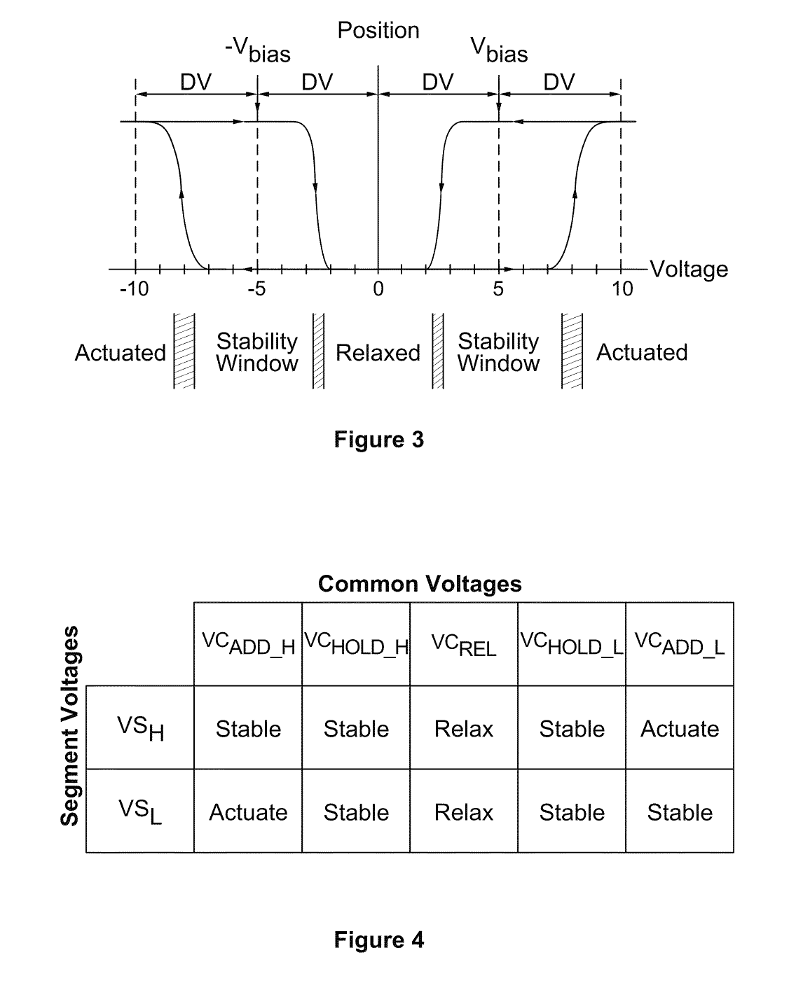

FIG. 3 shows an example of a diagram illustrating movable reflective layer position versus applied voltage for the IMOD of FIG. 1. For MEMS IMODs, the row/column (i.e., common/segment) write procedure may take advantage of a hysteresis property of these devices as illustrated in FIG. 3. An IMOD may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an IMOD when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

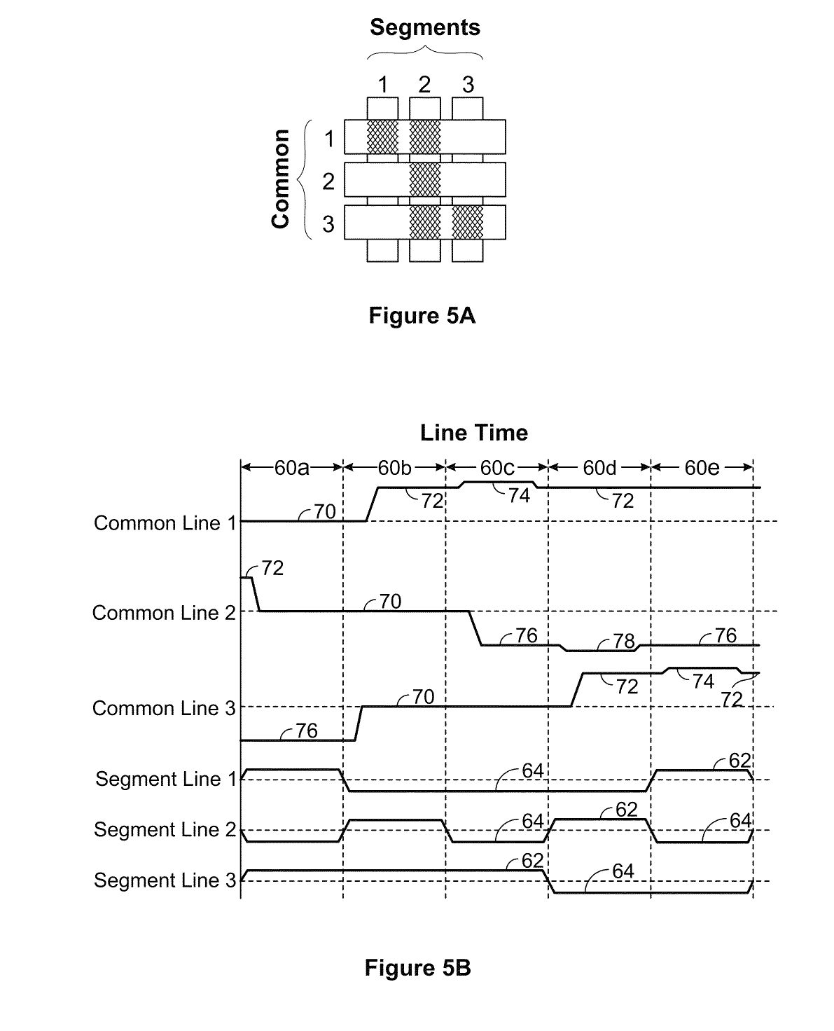

As illustrated in FIG. 4 (as well as in the timing diagram shown in FIG. 5B), when a release voltage VC_{REL} is applied along a common line, all IMOD elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the IMOD will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 IMOD display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the IMODs, as none of common lines 1, 2 or 3 are being exposed to voltage levels causing actuation during line time 60a (i.e., VC_{REL}−relax and VC_{HOLD}_{_{—}}_{L}−stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

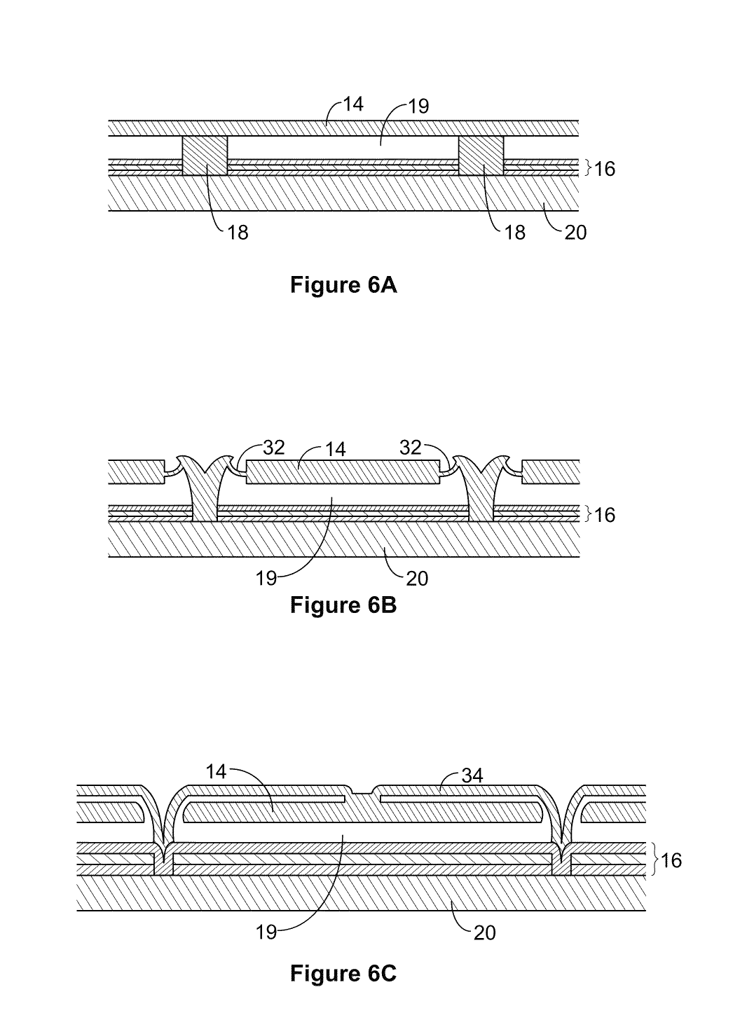

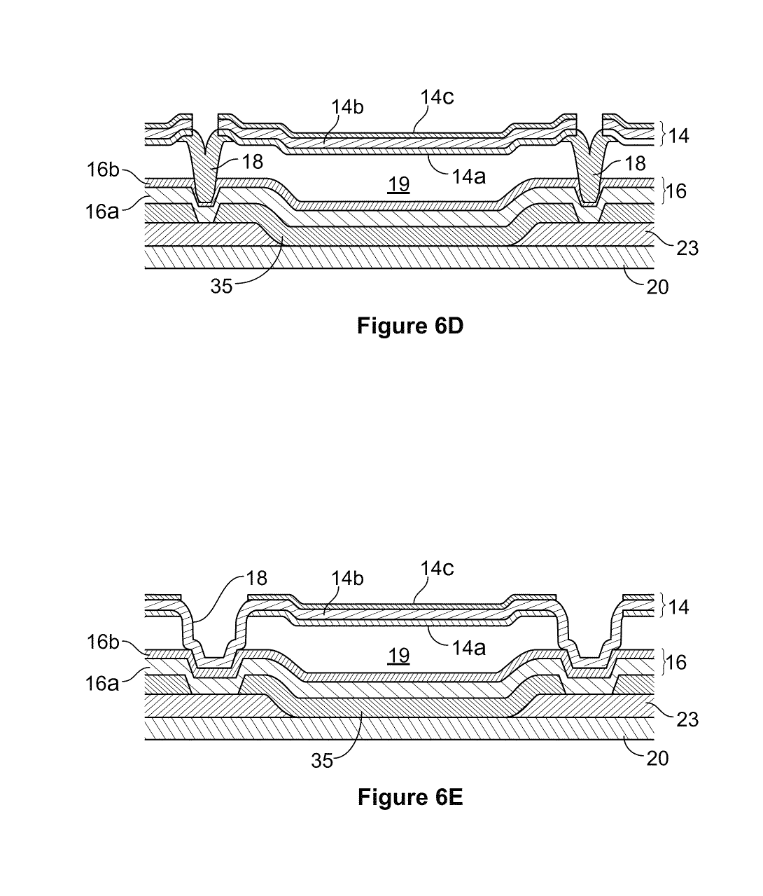

The details of the structure of IMODs that operate in accordance with the principles set forth above may vary widely. For example, FIGS. 6A-6E show examples of cross-sections of varying implementations of IMODs, including the movable reflective layer 14 and its supporting structures. FIG. 6A shows an example of a partial cross-section of the IMOD display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a SiO₂ layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, tetrafluoromethane (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self-supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the IMOD is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as patterning.

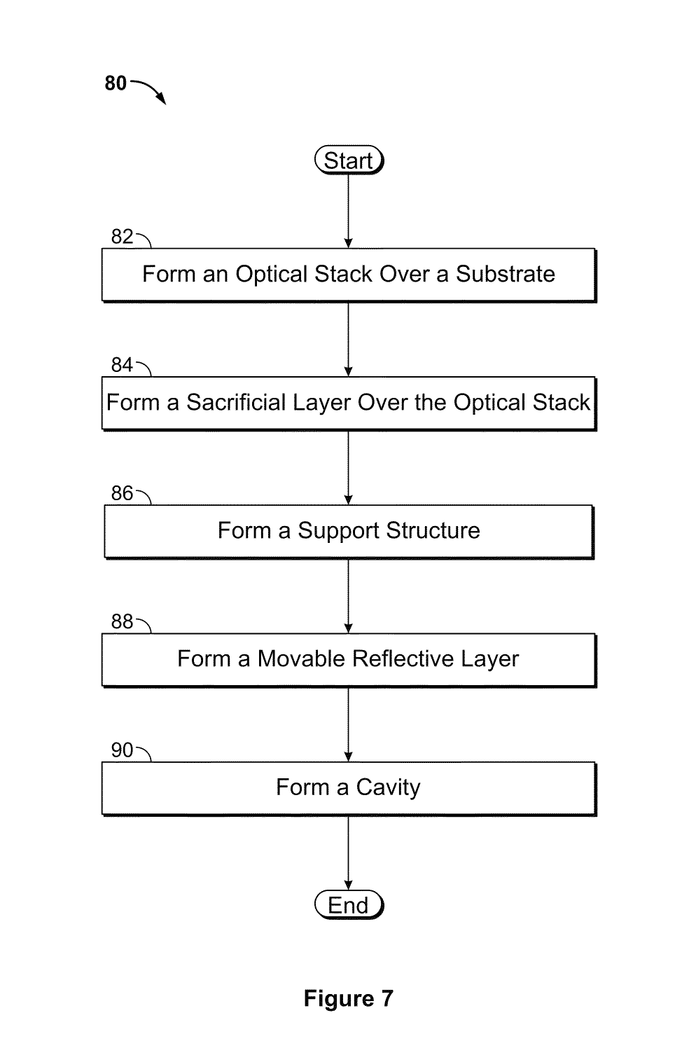

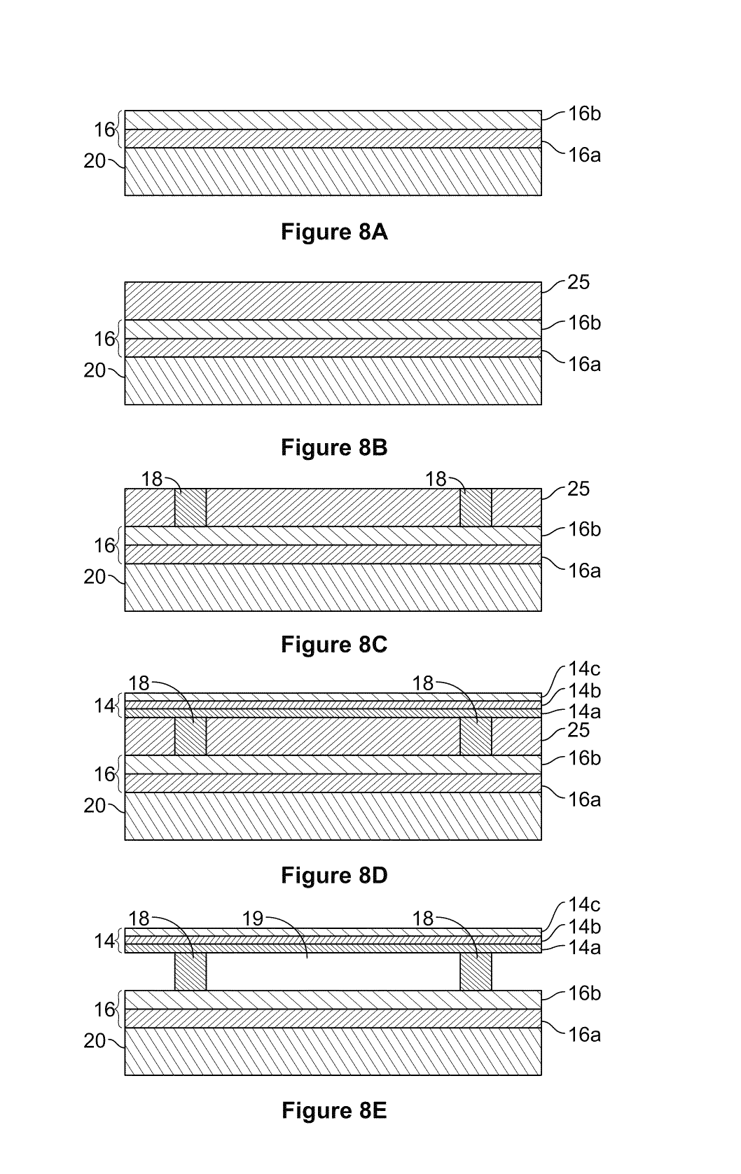

FIG. 7 shows an example of a flow diagram illustrating a manufacturing process 80 for an IMOD, and FIGS. 8A-8E show examples of cross-sectional schematic illustrations of corresponding stages of such a manufacturing process 80. In some implementations, the manufacturing process 80 can be implemented to manufacture, e.g., IMODs of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting IMODs 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, such as silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (such as aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated IMOD formed at block 88, the movable reflective layer 14 is typically not movable at this stage. A partially fabricated IMOD that contains a sacrificial layer 25 also may be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as molybdenum (Mo) or amorphous silicon (Si) may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

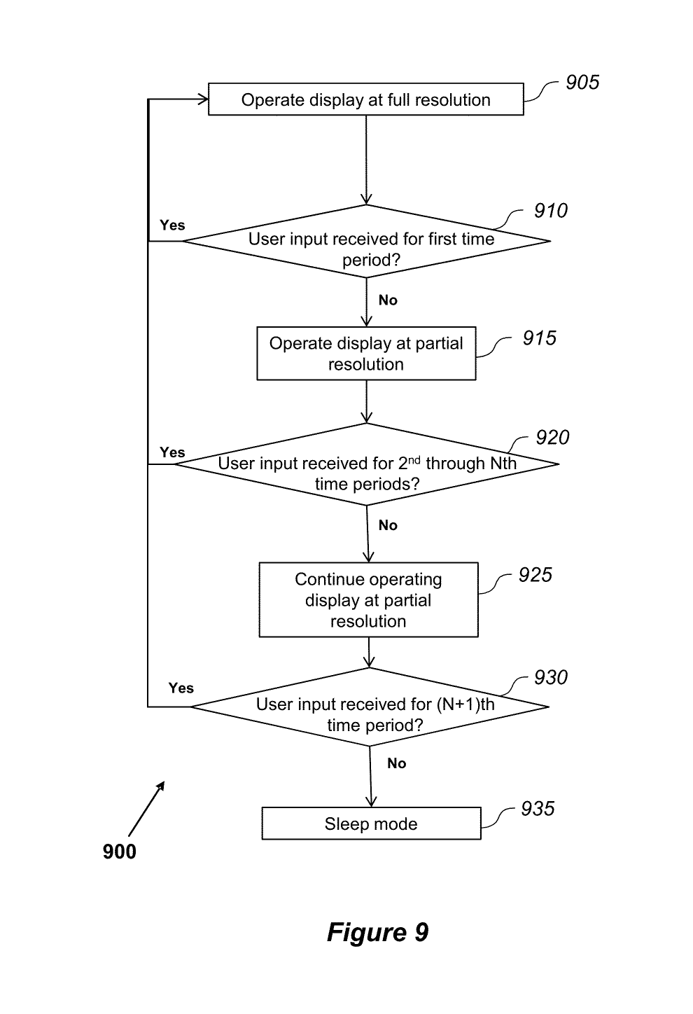

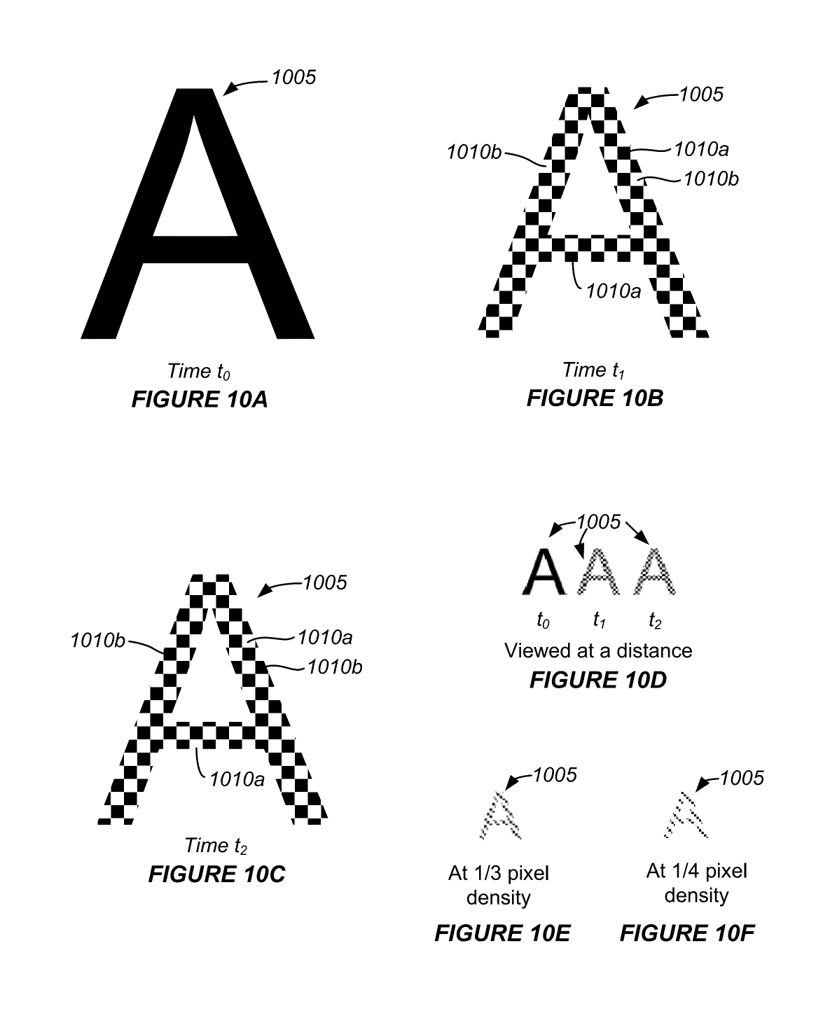

FIG. 9 shows an example of a flow diagram illustrating a process of controlling a display according to some implementations provided herein. Process 900 is an example of a CPSS process. FIGS. 10A-10F show examples of displays being controlled according to a process outlined in FIG. 9.

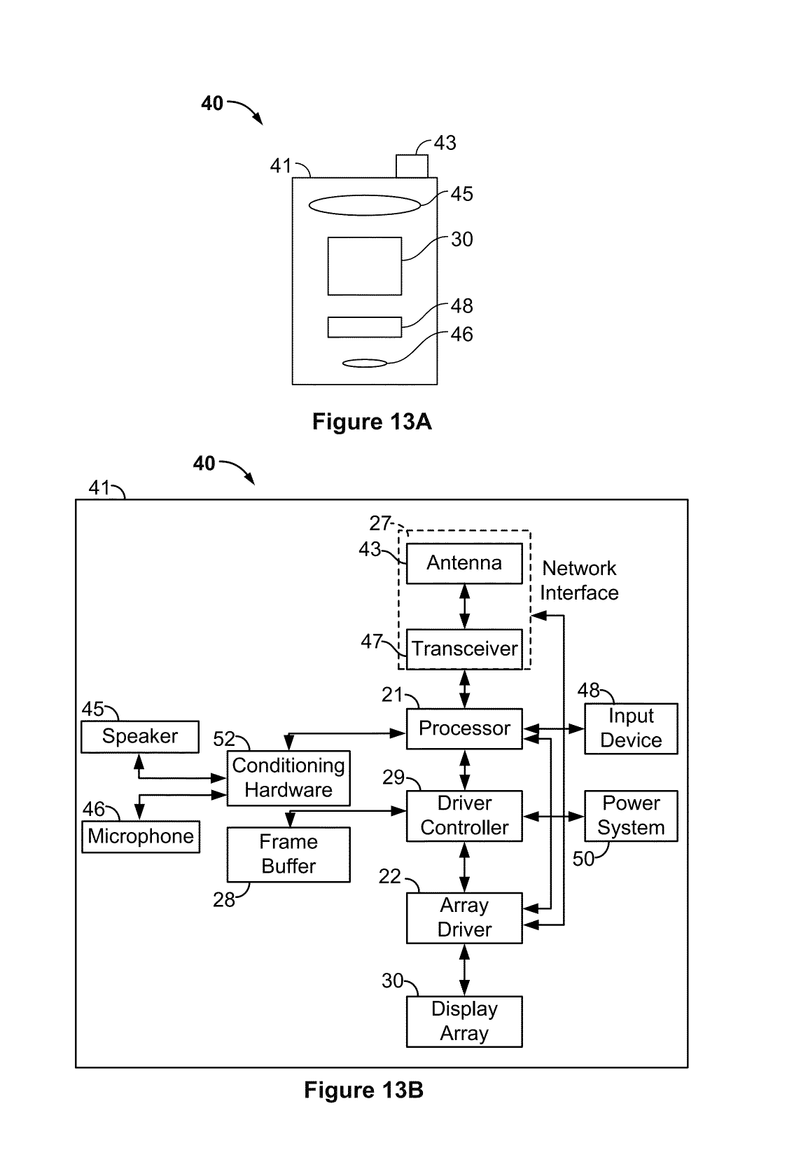

The blocks of the process 900 (and other processes described herein) may be performed, at least in part, by one or more microcontrollers, central processing units (CPUs) or logic units that are configured to control the operation of a display device, such as the display device 40 that is described below with reference to FIGS. 13A and 13B. In some such implementations, the process 900 may be implemented by a driver controller and/or a processor such as the driver controller 29 and the system processor 21 shown in FIGS. 13A and 13B and described below. Such controllers may be implemented in many ways. For example, a driver controller may be associated with the system processor as a stand-alone integrated circuit (IC). Alternatively, such controllers may be embedded in the system processor as hardware, embedded in the processor as software, or fully integrated in hardware with an array driver or other such component.

However, the process 900 and other processes described herein are not limited to use in controlling IMOD displays. Many other types of displays may be controlled according to such CPSS processes. For example, a plasma display, an LCD display (including but not limited to an organic LED (OLED) display), a light-emitting diode (LED) display, an electrophoretic display, a cathode ray tube display, or any other suitable type of display may be controlled according to the CPSS processes described herein.

Process 900 begins by operating a display at full resolution. (Block 905.) FIG. 10A depicts an example of an image 1005 that is shown on the display at this time, which may be referred to herein as time t₀. In this example the image 1005 is the letter “A,” but the process 900 applies to any type of content that may be displayed.

Referring again to FIG. 9, in block 910 it is determined whether user input has been received. The user input may be, for example, a touch on a touch screen, an indication of a user's gesture, an indication that a button has been depressed, etc. In this example, the CPSS is activated if no user input is received for a first period of time (such as 10 seconds, 20 seconds, 30 seconds, a minute, etc.). In some implementations, the first period of time may be set according to user input. In some implementations, the first period of time may be set automatically according to the type of content being presented on the display. For example, the first period of time may be longer when a display device is being used as an e-reader than when a display device is being used to browse web pages. If user input has been received within the first period of time, the display continues to be operated at full resolution. (Block 905.)

However, if user input has not been received within the first period of time, the display will be operated at a partial resolution. (Block 915.) In some implementations, the display is operated at a partial resolution by switching off at least some display elements (pixels or subpixels) that would otherwise be activated to form an image. In this example, the display is operated at half of the normal resolution when the CPSS is activated: every other pixel of the display is turned off. When the display is being operated at partial resolution, the amount of power consumed by the display may be substantially reduced because some of the pixels are not being activated. For emissive displays, the reduction in power consumption may be quite substantial when the display is being operated at partial resolution.

FIG. 10B shows one example of a display being operated at half of the normal resolution. FIG. 10B depicts the image 1005 at time t₁, after the first period of time has elapsed. In this example, the even-numbered pixels 1010a within the image 1005 are activated, whereas the odd-numbered pixels 1010b within the image 1005 have been switched off. Although only a portion of the content shown on a display is depicted in FIGS. 10A-10F, in some implementations substantially all of the pixels in the display are controlled in a similar manner. Moreover, although edges of some of the pixels 1010 are shown in FIGS. 10B-10F as being truncated at the edges of the letter “A,” the actual pixels 1010 would not be truncated in this matter. The truncation is merely made to conform with the outline of the letter “A” as shown in FIG. 10A.

In alternative implementations, more than half of the pixels within the image 1005 may be switched off in block 915. For example, 2 out of 3 pixels within the image 1005 may be switched off in block 915, making the display operate at a ⅓ resolution. One such example is shown in FIG. 10E. Alternatively, 3 out of 4 pixels within the image 1005 may be switched off in block 915, making the display operate at a ¼ resolution. FIG. 10F provides one example of a display being operated at a ¼ resolution.

In still other implementations, fewer than half of the pixels within the image 1005 may be switched off in block 915. In some such implementations, every third pixel may initially be switched off, making the display operate at a ⅔ resolution. In other such implementations, every fourth pixel may initially be switched off, making the display operate at a ¾ resolution.

Referring again to FIG. 9, if it is determined in block 920 that no user input has been received after a second period of time has elapsed (which may or may not be the same as the first time period), the display continues to be operated at a partial resolution. (Block 925.) However, the configuration of the display nonetheless changes. FIG. 10C depicts the image 1005 at time t₂, after the second period of time has elapsed. In this example, the odd-numbered pixels 1010b within the image 1005 are activated, whereas the even-numbered pixels 1010a within the image 1005 have been switched off.

Although the enlarged letter “A” depicted in FIGS. 10A-10C is a convenient scale for the purpose of describing the process 900, these drawings exaggerate the granularity of the image 1005. When a display is viewed at a normal viewing distance, the pixels would usually appear smaller than those shown in FIGS. 10A-10C. FIG. 10D shows a smaller-scale example of the image 1005 at times t₀, t₁ and t₂. Although the size of the letter “A” is still rather large and the pixel sizes are still exaggerated in FIG. 10D, the image 1005 appears less grainy than in FIGS. 10A-10C.

In alternative implementations wherein more or fewer than half of the pixels are switched off in block 915, the display may be controlled differently in block 925 as well. In some such examples, a scrolling process may be implemented after the initial step, to switch off each pixel and switch the other pixels on in a predetermined sequence.

For example, in some implementations wherein 2 out of 3 pixels within the image 1005 are switched off in block 915, 1 of the 2 pixels switched off in block 915 may be switched on in block 925, whereas the pixels that were left on in block 915 may be switched off in block 925. In some such implementations, the first 2 pixels in a group of 3 pixels may be switched off in block 915. If no user input has been received after a second period of time has elapsed, the 2^{nd} pixel may be switched on and the 3^{rd} pixel may be switched off. If no user input has been received after a third period of time has elapsed, the 2^{nd} pixel may be switched off and the 1^{st} pixel may be switched on. Other implementations may involve switching pixels (or other display elements) on and off in other sequences.

In some implementations, the device will eventually be put into a “sleep” mode if no user input is received for a predetermined period of time. The sleep mode may be similar to other such modes of operation known by those of ordinary skill in the art. The display may be switched off and device functionality may be minimized in order to further reduce power consumption.

In this example, the display device will be operated at a partial resolution after the 1^{st} through N^{th} time periods. Accordingly, in block 920, it is determined whether user input has been received for up to N time periods. N may be set to any suitable number, such as 5, 10, 20, 50, 100, etc. In some implementations, N may be set according to user preferences, whereas in other implementations N may be set by the manufacturer or another entity before the device is offered for sale. In block 930, it is determined whether user input has been received for more than N time periods. If so, the display device enters a sleep mode. (Block 935.) The device may be subsequently “awakened” by user input.

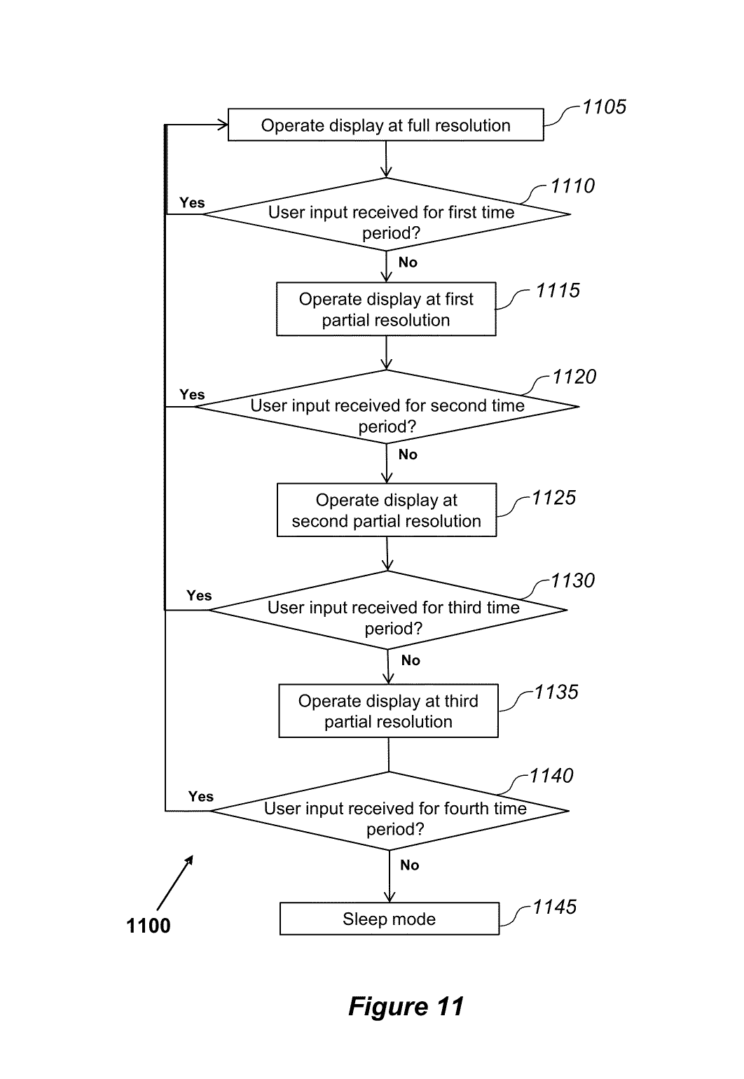

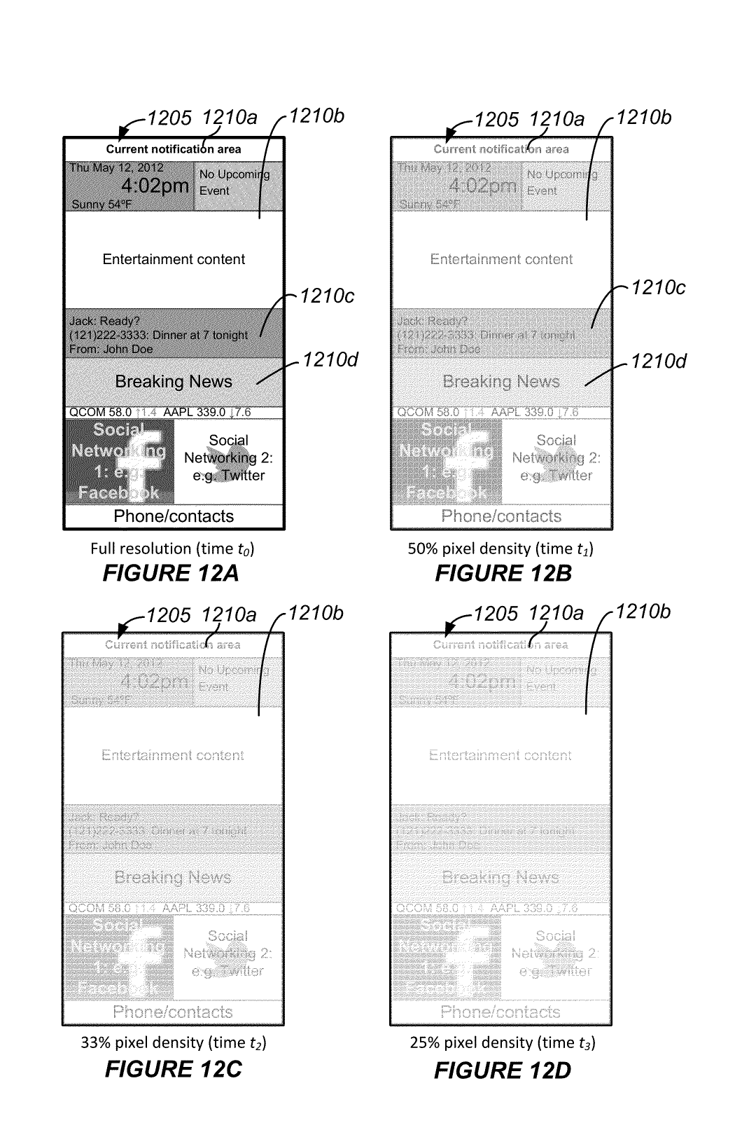

FIG. 11 shows an example of a flow diagram illustrating a process of controlling a display according to some alternative implementations provided herein. FIGS. 12A-12D show examples of displays being controlled according to an alternative process outlined in FIG. 11.

Process 1100 begins by operating a display at full resolution. (Block 1105.) FIG. 12A depicts an example of a screen 1205 that is shown on the display at this time, which may be referred to herein as time t₀. In this example, the screen 1205 is being displayed on a mobile device such as display device 40 that is described below with reference to FIG. 13A. Here, the screen 1205 includes the portions 1210, such as the portions 1210a and 1210b.

Referring again to FIG. 11, in block 1110 it is determined whether some type of event has occurred within a first time period. In this example, it is determined whether user input has been received within a first time period. However, in other examples it may be determined, e.g., whether data have been received that would trigger an update of content being displayed. The first period of time may be 10 seconds, 20 seconds, 30 seconds, a minute, or some other period of time. The first period of time may be set according to user input or may be pre-set by the manufacturer. If user input has been received within the first period of time, all of the portions 1210 of the display continue to be operated at full resolution. (Block 1105.)

However, if user input has not been received within the first period of time, the display will be operated at a first partial resolution. (Block 1115.) In some implementations, the display is operated at a first partial resolution by switching off at least some display elements (pixels or subpixels) that would otherwise be activated to form an image. In this implementation, the first partial resolution is half resolution.

FIG. 12B shows one example of a display being operated at half of the normal resolution. FIG. 12B depicts the screen 1205 at time t₁, after the first period of time has elapsed. In this example, substantially the entire display is operated at half of the normal resolution if user input has not been received within the first period of time: each of the portions 1210 is operated at half resolution.

However, in alternative implementations, the display device may be configured to display at least some of the portions 1210 at varying resolutions. For example, one of the portions 1210 (e.g., the portion 1210a) may be displayed at a full resolution while, at the same time, another of the portions 1210 ((e.g., the portion 1210b) may be displayed at a half resolution, a ¾ resolution, or some other resolution.

According to some such implementations, the resolution of a portion 1210 may be set according to the type of content being displayed in that portion and/or whether a portion 1210 has been refreshed or updated. In this example, the portion 1210a displays notifications, the portion 1210c displays text messages and the portion 1210d displays breaking news. In some implementations, if a new notification is received at least the portion 1210a will be displayed at a full resolution. If a new text message is received, at least the portion 1210c will be displayed at a full resolution and if breaking news is received, at least the portion 1210d will be displayed at a full resolution. However, the other portions 1210 may continue to be displayed at a partial resolution.

Referring again to FIG. 11, block 1115 may involve operations similar to those described above with reference to FIG. 9. For example, while the display is being operated at the first partial resolution, it may be determined whether an event has occurred (e.g., user input, an update, etc.) within a predetermined time. If not, the display will continue to be operated at the first partial resolution, but display elements that were activated may be switched off and vice versa. Multiple iterations of this process may occur while the display is operated at the first partial resolution.

However, in this example, if no user input is received for a second time period (as determined in block 1120), the display will be operated at a second partial resolution. (Block 1125.) FIG. 12C shows one such example, wherein the second partial resolution is ⅓ of the normal resolution. FIG. 12C depicts the screen 1205 at time t₂, after the second period of time has elapsed. In this example, substantially the entire display is operated at ⅓ resolution if user input has not been received within the second period of time: each of the portions 1210 is operated at ⅓ resolution.

Referring again to FIG. 11, block 1125 also may involve operations similar to those described above with reference to FIG. 9. While the display is being operated at the second partial resolution, it may be determined whether an event has occurred (e.g., user input, an update, etc.) within a predetermined time. If not, the display will continue to be operated at the second partial resolution, but display elements that were activated may be switched off and vice versa. In some such examples, a scrolling process may be implemented after the initial step, to switch off each pixel and switch the other pixels on in a predetermined sequence.

For example, the first 2 pixels in a group of 3 pixels may initially be switched off in block 1125. If no user input has been received within a predetermined time, the 2^{nd} pixel may be switched on and the 3^{rd} pixel may be switched off. If no user input has been received after a third period of time has elapsed, the 2^{nd} pixel may be switched off and the 1^{st} pixel may be switched on. Other implementations may involve switching pixels (or other display elements) on and off in other sequences.

Multiple iterations of this process may occur while the display is operated at the second partial resolution. However, in this implementation, if no user input is received for a third time period (as determined in block 1130), the display will be operated at a third partial resolution. (Block 1135.) FIG. 12D shows one such example, wherein the third partial resolution is ¼ of the normal resolution. FIG. 12D depicts the screen 1205 at time t₃, after the third period of time has elapsed. In this example, each of the portions 1210 is operated at ¼ resolution.

Referring again to FIG. 11, block 1135 also may involve operations similar to those described above with reference to FIG. 9. While the display is being operated at the third partial resolution, it may be determined whether an event has occurred (e.g., user input, an update, etc.) within a predetermined time. If not, the display will continue to be operated at the third partial resolution, but display elements that were activated may be switched off and vice versa. In some such examples, a scrolling process may be implemented after the initial step, to switch off each pixel and switch the other pixels on in a predetermined sequence.

In block 1140, it is determined whether an event has occurred within a fourth time period. In this implementation, it is determined whether user input has been received within the fourth time period. If so, the process returns to block 1105 and the display is operated at full resolution. If not, the display device enters a sleep mode. (Block 1145.) Although FIG. 11 does not so indicate, the display device may subsequently be activated upon the occurrence of an event, such as the receipt of user input.

FIGS. 13A and 13B show examples of system block diagrams illustrating a display device 40. The display device 40 can be, for example, a smart phone, a cellular or mobile telephone. However, the same components of the display device 40 or slight variations thereof are also illustrative of various types of display devices such as televisions, tablets, e-readers, hand-held devices and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD display, as described herein.

The components of the display device 40 are schematically illustrated in FIG. 12B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. In some implementations, a power system 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone integrated circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (such as an IMOD controller). Additionally, the array driver 22 can be a conventional driver or a bi-stable display driver (such as an IMOD display driver). Moreover, the display array 30 can be a conventional display array or a bi-stable display array (such as a display including an array of IMODs). In some implementations, the driver controller 29 can be integrated with the array driver 22. Such an implementation can be useful in highly integrated systems, for example, mobile phones, portable-electronic devices, watches or other small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power system 50 can include a variety of energy storage devices. For example, the power system 50 may include a rechargeable battery, such as a nickel-cadmium battery or a lithium-ion battery. In implementations using a rechargeable battery, the rechargeable battery may be chargeable using power coming from, for example, a wall socket of a photovoltaic device or array. Alternatively, the rechargeable battery can be wirelessly chargeable. The power system 50 also can include a renewable energy source, a capacitor, or a solar cell, including a plastic solar cell or solar-cell paint. The power system 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations. The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other possibilities or implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of an IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method, comprising:
operating a display at a full resolution;
determining that no user input has been received for a first time period; and
operating the display at a first partial resolution.

2. The method of claim 1, wherein operating the display at the first partial resolution involves operating substantially the entire the display at the first partial resolution.

3. The method of claim 1, wherein operating the display at the first partial resolution occurs because of the determination that no user input has been received for the first time period.

4. The method of claim 1, wherein operating the display at the first partial resolution involves switching off a first plurality of display elements.

5. The method of claim 4, wherein the display elements are pixels or subpixels.

6. The method of claim 5, wherein the display elements are pixels and wherein operating the display at the first partial resolution involves switching off a first plurality of pixels.

7. The method of claim 6, further comprising:
determining that no user input has been received for a second time period;
switching on at least some of the first plurality of pixels; and
switching off a second plurality of pixels.

8. The method of claim 6, wherein the first plurality of pixels is substantially half of a total number of display pixels.

9. The method of claim 6, wherein switching off the first plurality of pixels involves switching off every other pixel.

10. The method of claim 5, further comprising:
determining that no user input has been received for a second time period;
switching on the first plurality of pixels; and
switching off a second plurality of pixels.

11. The method of claim 10, wherein the second plurality of pixels includes substantially all of the pixels of the display other than the first plurality of pixels.

12. The method of claim 6, wherein the first plurality of pixels includes approximately ⅔ of the pixels of the display.

13. The method of claim 12, wherein switching off the first plurality of pixels involves switching off every second and third pixel.

14. The method of claim 6, wherein the first plurality of pixels includes approximately ¾ of the pixels of the display.

15. The method of claim 14, wherein switching off the first plurality of pixels involves switching off every second, third and fourth pixel.

16. The method of claim 1, further comprising:
determining that no user input has been received for a second time period; and
operating the display at a second partial resolution that is a lower resolution than the first partial resolution.

17. An apparatus, comprising:
a display;
a user input device; and
a control system configured for communication with the display and the user input device, the control system configured for:
operating the display at a full resolution;
determining that no user input has been received from the user input device for a first time period; and
operating substantially the entire display at a first partial resolution.

18. The apparatus of claim 17, wherein operating the display at the first partial resolution involves switching off a first plurality of pixels.

19. The apparatus of claim 18, wherein the control system is further configured for:
determining that no user input has been received for a second time period;
switching on at least some of the first plurality of pixels; and
switching off a second plurality of pixels.

20. The apparatus of claim 18, wherein the first plurality of pixels is substantially half of a total number of display pixels.

21. The apparatus of claim 18, wherein switching off the first plurality of pixels involves switching off every other pixel.

22. The apparatus of claim 21, wherein the control system is further configured for:
determining that no user input has been received for a second time period;
switching on the first plurality of pixels; and
switching off a second plurality of pixels.

23. The apparatus of claim 22, wherein the second plurality of pixels includes substantially all of the pixels of the display other than the first plurality of pixels.

24. The apparatus of claim 18, wherein the first plurality of pixels includes approximately ⅔ of the pixels of the display.

25. The apparatus of claim 24, wherein switching off the first plurality of pixels involves switching off every second and third pixel.

26. The apparatus of claim 18, wherein the first plurality of pixels includes approximately ¾ of the pixels of the display.

27. The apparatus of claim 26, wherein switching off the first plurality of pixels involves switching off every second, third and fourth pixel.

28. The apparatus of claim 17, wherein the control system is further configured for:
determining that no user input has been received for a second time period; and
operating the display at a second partial resolution that is a lower resolution than the first partial resolution.

29. A non-transitory medium having software stored thereon, the software including instructions for:
operating a display at a full resolution;
determining that no user input has been received for a first time period; and
operating substantially the entire display at a first partial resolution.

30. The non-transitory medium of claim 29, wherein operating the display at the first partial resolution involves switching off a first plurality of pixels.

31. The non-transitory medium of claim 30, wherein the software includes instructions for:
determining that no user input has been received for a second time period;
switching on at least some of the first plurality of pixels; and
switching off a second plurality of pixels.

32. The non-transitory medium of claim 30, wherein the first plurality of pixels is substantially half of a total number of display pixels.

33. The non-transitory medium of claim 30, wherein switching off the first plurality of pixels involves switching off every other pixel.

34. The non-transitory medium of claim 33, wherein the software includes instructions for:
determining that no user input has been received for a second time period;
switching on the first plurality of pixels; and
switching off a second plurality of pixels.

35. The non-transitory medium of claim 34, wherein the second plurality of pixels includes substantially all of the pixels of the display other than the first plurality of pixels.

36. An apparatus, comprising:
display means;
user input means; and
control means for:
operating the display at a full resolution;
determining that no user input has been received from the user input means for a first time period; and
operating substantially the entire display at a first partial resolution.

37. The apparatus of claim 36, wherein operating the display at the first partial resolution involves switching off a first plurality of pixels.

38. The apparatus of claim 37, wherein the control means is further configured for:
determining that no user input has been received from the user input means for a second time period;
switching on at least some of the first plurality of pixels; and
switching off a second plurality of pixels.

39. The apparatus of claim 37, wherein the first plurality of pixels is substantially half of a total number of display pixels.

40. The apparatus of claim 37, wherein switching off the first plurality of pixels involves switching off every other pixel.

41. The apparatus of claim 40, wherein the control means is further configured for:
determining that no user input has been received from the user input means for a second time period;
switching on the first plurality of pixels; and
switching off a second plurality of pixels.

42. The apparatus of claim 41, wherein the second plurality of pixels includes substantially all of the pixels of the display other than the first plurality of pixels.

43. The apparatus of claim 36, wherein the user input means includes at least one of a touch screen, a keyboard, a mouse, a key pad, a microphone, a camera or a gesture-sensing apparatus.
